(19) United States
(12) Patent Application Publication
(10) Pub. No.: US 2003/0119588 A1
(43) Pub. Date: Jun. 26, 2003

(54) Method and apparatus for servicing a staked universal joint

(76) Inventors: Joseph B. Schlegelmann, Marlette, MI (US); Michael M. Start, Shelby Township, MI (US); Pete A. Nietupski, Romulus, MI (US)

Correspondence Address: John E. Kajander, Visteon Global Technologies, Inc., One Parklane Boulevard, 728 East Parklane Towers, Dearborn, MI, 48126, US

(21) Appl. No.: 10/028,241

(22) Filed: Dec. 20, 2001

(51) Int. Cl. F16D 3/16; F16D 3/26; F16D 3/50

(52) U.S. Cl. 464/130

(57) ABSTRACT

A retaining washer and method for servicing staked universal joints. The invention describes methods of servicing staked universal joints which maintain the quality of the original factory balance on the universal joint.

### FIELD OF THE INVENTION

The present invention relates generally to universal joints in an automobile, and more particularly to servicing staked universal joints.

### DISCLOSURE INFORMATION

Standard universal joints are assembled using spring clips to hold the bearing cups, bearings and spider joints in place. These clips fit into corresponding grooves cut into the bearing hole of the universal joint yoke. The bearings in these joints are serviced by removing the spring clips and pressing out the old bearing cups. New bearings and cups are then inserted and new spring clips are installed into the yoke grooves.

Staked universal joints do not use a spring clip to hold the bearing cups in place, but rather rely on staking to locate and hold the bearing cups. Staking holds the bearing cups in place in a more controllable manner than spring clips, allowing for improved balancing characteristics over spring clipped universal joints. These improved balance characteristics result in a quieter driveline system and less wear on all of the bearings in the driveline system.

The staking process relies on deforming metal in the wall of the bearing hole to form stakes which hold the bearing cup in place. Some embodiments use a counterbored bearing hole and form stakes from the shoulder of the counterbore to hold the bearing cup in place. Stakes are formed from this choulder material and form staking grooves in the counterbore shoulders. In some other embodiments without counterbored bearing holes, the staking process results in staking grooves being formed into the wall of the bearing hole, from which metal is deformed in order to form the stakes.

Staked universal joints are not currently serviceable since they lack spring clips. Instead, staked universal joints must be completely replaced when the bearings and/or bearing cups wear out. If bearing cups of a staked universal joint were to be removed and new bearing cups re-staked onto the joint, the axial balance of the driveshaft would not be maintained and the result would be a significantly noisier driveline system than the factory original.

It would be desirable, therefore, to provide a method and apparatus which not only allows for the replacement of bearings and bearing cups in staked universal joints, but also maintains the same balance standard as the factory balance specification.

### SUMMARY OF THE INVENTION

The present invention overcomes the disadvantages of the prior art approaches by providing a retaining washer for servicing a staked universal joint which includes an outer radius; a top surface; at least one finger arranged about the outer radius along the top surface, such that the finger or fingers cooperatively engage at least one positioning feature when inserted against a bearing cup in a universal joint. The retainer apparatus further includes a bottom surface situated so that when the finger or fingers are cooperatively engaged with the positioning feature, the bottom surface will retain a replacement bearing cup in a balanced position within the bearing hole.

The present invention also overcomes the disadvantages of the prior art approaches by providing a method for servicing staked universal joints comprising the steps of (a) machining away stakes in the inner radius of a bearing hole on a universal joint yoke;(b) removing an original bearing cup from an original bearing cup position in said bearing hole; inserting a new bearing cup and retaining washer having at least one finger into the bearing hole until the finger or fingers engage the grooves formed by the original staking process and the new bearing cup reaches a predetermined bearing cup position which substantially maintains the axial balance created in the part at the factory.

It is an object and advantage that the present invention allows for the servicing of staked universal joints while substantially maintaining an original axial balance.

These and other advantages, features and objects of the invention will become apparent from the drawings, detailed description and claims which follow.

### BRIEF DESCRIPTION OF THE DRAWINGS

FIG. 1 is an illustration of a typical spring clip used in universal joints.

FIG. 2 is an illustration of the end view of a typical staked universal joint.

FIG. 3 is an illustration of a cross-sectional side view of a typical staked universal joint.

FIG. 4 is an illustration of a top view of a retainer apparatus.

FIG. 5 is an illustration of a side view of a retainer apparatus contained within a yoke.

FIG. 6 is a top view along the axis of the bearing hole of a retainer apparatus installed into a universal joint after servicing.

FIG. 7 is an illustration of an alternative retainer apparatus design.

FIG. 8 is an illustration of a retainer washer which uses a shoulder as an alternate positioning feature rather than a stake grove.

FIG. 9 is an illustration of retainer washer which has only one finger.

### DESCRIPTION OF THE PREFERRED EMBODIMENT(S)

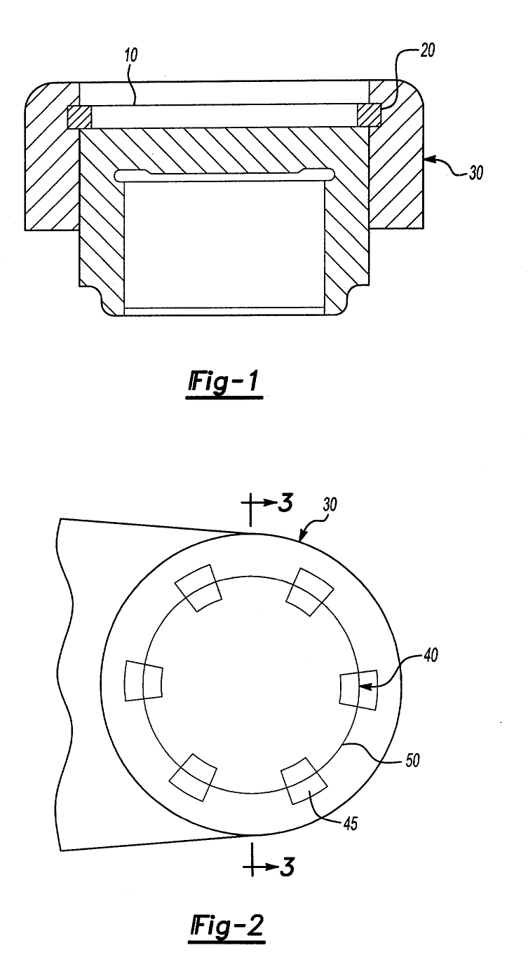

Referring now to the drawings, FIG. 1 shows a typical serviceable universal joint which employs a spring clip 10. The spring clip 10 seats in a groove 20 cut in the universal joint yoke 30. Variations due to tolerancing affect the balance capability of this type of joint. The grooves, the location of the grooves, the bearing cups, the spiders and the yoke itself all add complexity to the balancing process.

In FIG. 2, a plan view of a staked universal joint is shown. Note that each stake 40 is formed from the inner wall 50 of the bearing hole formed in the universal joint yoke 30. Note how the staking process leaves staking grooves 45 in the wall of the bearing hole.

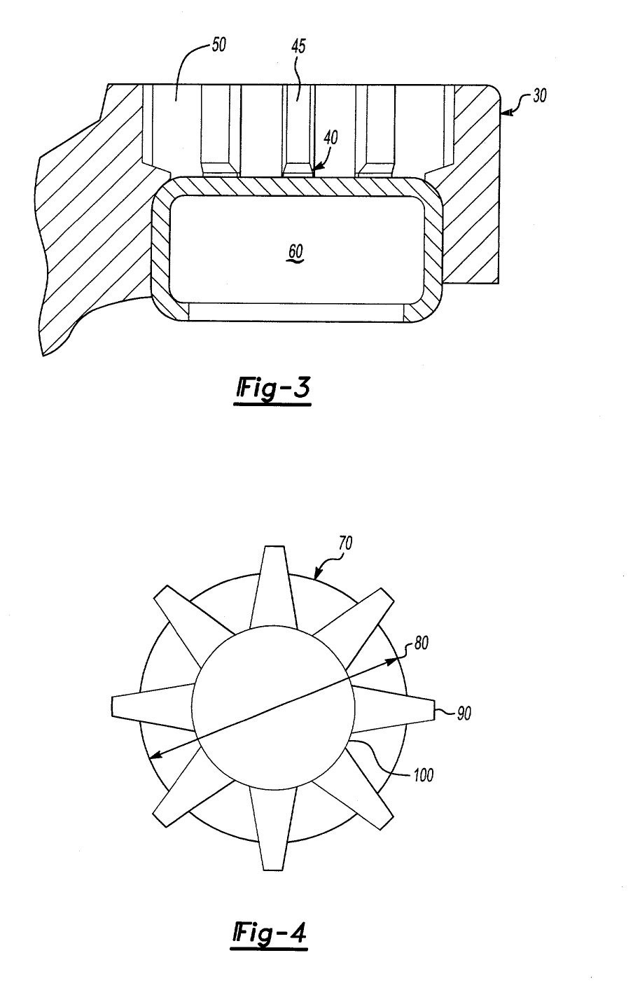

In FIG. 3, a side sectional view of a staked universal joint is shown. This universal joint has a bearing hole which is not counterbored and the stakes 40 are formed from the walls 50 of the bearing hole itself. This process leaves staking grooves 45 in the bearing hole wall down to the depth of the stakes 40 and thus provides a reference as to the original depth of the original bearing cup 60. The depth of the bearing cup 60 is determined by the formation of the stakes 40 vertically along the inner wall 50 of the bearing hole. By controlling the depth of the bearing cup by controlling the formation of these stakes in the manufacturing process, the original equipment manufacturer can maintain much higher balance specification standards than can be maintained in a conventional system as shown in FIG. 1.

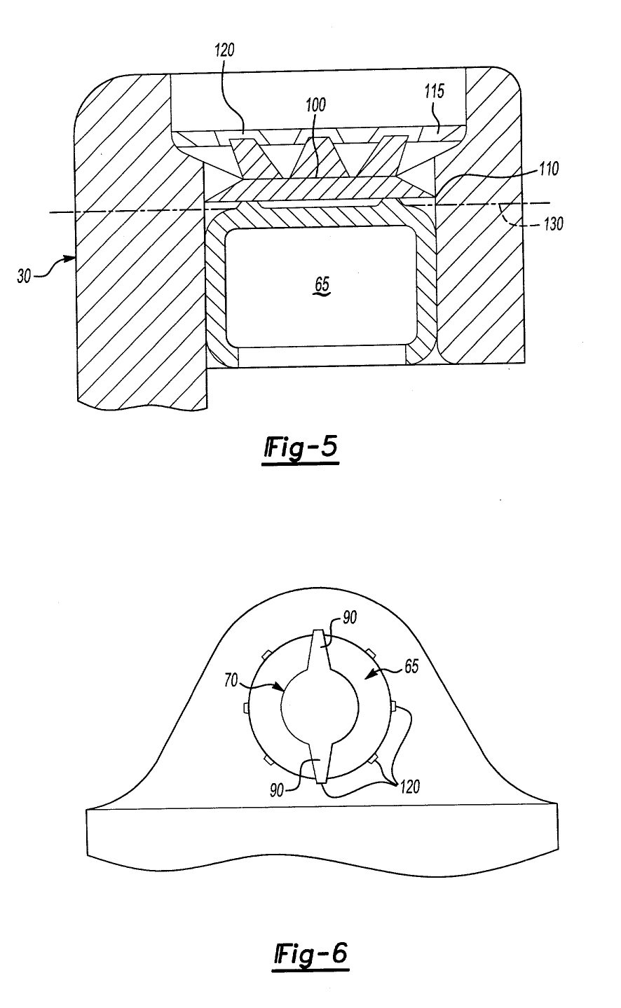

FIGS. 4 and 5 illustrate a retainer apparatus 70 for retaining a new bearing cup 65 within the bearing hole of a staked universal joint yoke after the old bearing cup and stakes have been removed. The retainer apparatus 70 has an outer radius 80 that is substantially the same diameter as the inner radius of the bearing hole in the universal joint yoke. The new bearing cup 65 may be of a different size than the original bearing cup in order to accommodate the retainer apparatus 70. Balance in the universal joint is maintained as long as new bearing cups 65 and new retainer apparatus 70 are installed on both sides of the universal joint yoke 30.

Fingers 90 are arranged about the outer radius 80 along a top surface 100, such that the fingers 90 cooperatively engage positioning features, in this case staking grooves, when the bottom surface 110 of the retainer washer is at a predetermined position 130. The fingers 90 may form an angle in relation to the top surface 100, or may be coplanar with the top surface 100 as long as the fingers provide enough retention within the bearing hole to maintain the new bearing cup 65 in its balance position. Note in FIG. 5 that the replacement bearing cup 65 and retaining washer 70 may be manufactured from a single piece of material or fixedly attached together to form one piece before insertion into the bearing hole in the yoke 30.

The bottom surface 110, is spaced a predetermined distance from the fingers 90 and top surface 100 such that when the fingers 90 are engaged in staking grooves 120 within a universal joint yoke 30, the bottom surface 110 is located in a known position with respect to the reference position of the original bearing cup 130. This allows for accurate control of the axial balance of the joint by precisely controlling the placement of the mass of the bearing cup and retainer washer. In conventional systems, new retainer washers and bearing cups are not adjustable, and the balance of the universal joint is not retained after servicing. FIG. 5 also shows a counterbored bearing hole where the stakes and stake grooves 120 appear in the shoulder 115 of the counterbore.

FIG. 6 shows a top view of a universal joint after servicing. In this view, staking grooves 120 are formed in a shoulder 122 within the bearing hole. This shoulder provided the original material from which the stakes were formed. The replacement bearing cup 65 has been inserted into the bearing hole of yoke 30 to a controlled depth, a known position with respect to the original bearing cup, by use of a retainer washer 70. The retainer washer controls the depth of insertion of the replacement bearing cup 65 when its fingers 90 engage with positioning features, in this case stake grooves 120. The stake grooves 120 are all that is left once the stakes have been machined away before the original bearing cup was removed. Note how the fingers insert into the stake grooves 120, which act as the positioning feature in this instance. The grooves will always be a certain distance from the top of the original bearing cup for a given process. Thus the stake grooves 120 can be used as a position feature to control the relative position of a new bearing cup with respect to the location of the original bearing cup.

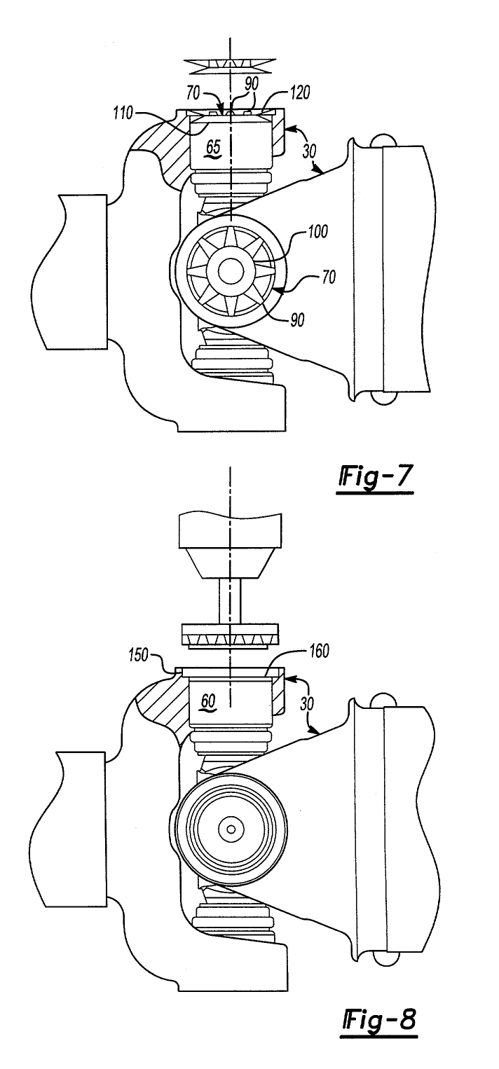

FIG. 7 shows an alternative design of a retainer washer 70 having only two fingers 90 which press fit into the stake grooves 120 to hold the replacement bearing cup 65 in place.

FIG. 8 shows an alternate method to control the depth of the replacement bearing cup. In this view, the stakes and stake grooves are completely machined away by a counterbore 150 with a counterbore tool while the old bearing cup 60 is still in its original location. The depth of cut of the counterbore 150 is controlled by stopping the counterbore a known distance from the old bearing cup 60. This offset counterbore forms a shoulder 160 at a known distance from the old bearing cup 60. This shoulder 160 forms a positioning feature which a retaining washer 70 can use to fix the position of a replacement bearing cup 65 at a known position with respect to the original bearing cup 60.

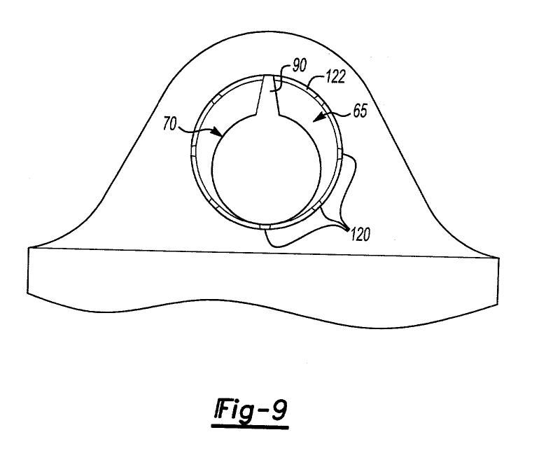

FIG. 9 shows a retainer washer which relies on only one finger 90 and the opposite side of the retaining washer 70 to form a press fit into a bearing hole on a yoke 30.

What is claimed is:

1. A retaining washer for mounting a replacement bearing cup to a universal joint yoke wherein said replacement bearing cup has a balance position referenced to the location of an original bearing cup position and wherein said yoke has at least one bearing hole, said bearing hole further having a bearing hole wall and at least one bearing cup positioning feature, said retaining washer comprising:
(a) A main body having an outer diameter, a top surface and a bottom surface; and,
(b) at least one finger arranged about said outer diameter along said top surface, such that said at least one finger cooperatively engages at least one of said at least one bearing cup positioning features when said retaining washer is inserted into bearing hole, further wherein said at least one finger is positioned with respect to said bottom surface to that said bottom surface will retain said replacement bearing cup in said balance position when said at least one finger is cooperatively engaged with said at least one bearing cup positioning feature.

2. A retaining washer according to claim 1 wherein said outer diameter provides a press fit with said bearing hole wall.

3. A retaining washer according to claim 1 wherein the outer edge of said at least one finger cooperating with said outer diameter provides a press fit with at least one of said at least one bearing cup positioning features and said bearing hole wall.

4. A retaining washer according to claim 1 wherein said retaining washer has at least two fingers wherein the outer edges of said at least two fingers provide a press fit with one of said at least one bearing hole wall.

5. A retaining washer according to claim 1 wherein said retaining washer has at least two fingers wherein the outer edges of said at least two fingers provide a press fit with one of said at least one bearing cup positioning features.

6. A bearing retainer to replace a bearing cup in a staked universal joint yoke wherein said yoke has at least one bearing hole, each of said at least one bearing holes further having a bearing hole wall and at least one bearing cup positioning features, said bearing retainer comprising:
(a) a bearing cup, having an outer diameter, a top surface and a balance position; and
(b) at least one finger arranged about said top surface along said outer radius, such that said at least one finger cooperatively engages said at least one bearing cup positioning feature to position said bearing cup in said balance position.

7. A retaining washer according to claim 6 wherein said outer diameter provides a press fit with said bearing hole wall.

8. A bearing retainer according to claim 6 wherein the outer edge of said at least one fingers cooperating with said outer diameter provides a press fit with at least one of said at least one bearing cup positioning features and said bearing hole wall.

9. A bearing retainer according to claim 6 wherein said bearing retainer has at least two fingers, further wherein the outer edge of said at least two fingers provide a press fit with said bearing hole wall.

10. A bearing retainer according to claim 6 wherein said bearing retainer has at least two fingers, further wherein the outer edge of said at least two fingers provide a press fit with said at least one bearing cup positioning feature.

11. A method for servicing a staked universal joint yoke with a replacement bearing cup and a retaining washer, wherein said yoke has at least one bearing hole, an original bearing cup, further wherein each of said at least one bearing hole has at least one staking feature, further wherein said replacement bearing cup has a balance position, said method comprising the steps of:
(a) removing a portion of at least one of said at least one staking features;
(b) removing said original bearing cup from said bearing hole;
(c) partially inserting said replacement bearing cup into said bearing hole; and,
(d) inserting said retaining washer until said replacement bearing cup reaches said balance position.

12. A method for servicing a staked universal joint yoke with a replacement bearing cup and a retaining washer wherein said replacement washer has at least one finger capable of cooperatively engaging a positioning feature, wherein said yoke has at least one bearing hole, at least one original bearing cup having an original bearing cup position, further wherein each of said at least one bearing holes has at least one staking feature which sakes the original bearing cup in place, further wherein said replacement bearing cup has a balance position, said method comprising the steps of:
(a) forming a positioning feature into said yoke, said positioning feature located at some fixed point in relation to one of said at least one original bearing cup position;
(b) removing said one of said at least one original bearing cup from said one of at least one bearing hole;
(c) partially inserting said replacement bearing cup into said one of said at least one bearing hole; and,
(d) inserting said retaining washer into said one of said at least one bearing hole until said retaining washer cooperatively engages said positioning feature.

13. A method according to claim 12, further comprising the step of removing said at least one staking features from one of said at least one bearing holes.

14. A method for servicing a staked universal joint yoke with a self-retaining replacement bearing cup, wherein said yoke has at least one bearing hole, an original bearing cup, further wherein each of said at least one bearing hole has at least one staking feature, further wherein said replacement bearing cup has a balance position, said method comprising the steps of:
(a) removing a portion of at least one of said at least one staking features;
(b) removing said original bearing cup from said bearing hole; and,
(c) inserting said replacement bearing cup into said bearing hole to said balance position.

15. A method for servicing the original bearing cups in a staked universal joint yoke with a first and a second replacement bearing cup and a first and a second retaining washer, wherein said yoke has an original axial balance about the longitudinal axis of the yoke, the method comprising the steps of:
(a) removing said two original bearing cups, while maintaining a first and second reference positions in response to original locations of said original bearing cups; and,
(b) inserting said first and second replacement bearing cups and said first and second retainer washers in response to said first and second reference positions such that the center of mass of said first replacement cup and said first retaining washer is an equal distance form said longitudinal axis of the yoke as the center of mass of said second replacement cup and said second retainer.
